(19) United States
(12) Patent Application Publication
(10) Pub. No.: US 2018/0167691 A1
(43) Pub. Date: Jun. 14, 2018

(54) EASY PLAY FROM A SPECIFIED POSITION IN TIME OF A BROADCAST OF A DATA STREAM

(71) Applicant: The DIRECTV Group, Inc., El Segundo, CA (US)

(72) Inventors: Sudheer Bandela, Torrance, CA (US); Binny Asarikuniyil, Cerritos, CA (US); Hai Kim Nguyen, Torrance, CA (US); Heather Nga Truong, Anaheim, CA (US)

(21) Appl. No.: 15/377,419

(22) Filed: Dec. 13, 2016

(51) Int. Cl. H04N 21/472; H04N 21/81; H04N 21/8549; H04N 21/845; H04N 21/422; H04N 21/2543; H04N 21/482; H04N 21/435

(52) U.S. Cl. CPC H04N 21/47217; H04N 21/812; H04N 21/8549; H04N 21/8456; H04N 21/435; H04N 21/8133; H04N 21/2543; H04N 21/482; H04N 21/42204

(57) ABSTRACT

Facilitating play from a specified position in time of a broadcast of a data stream is presented herein. A method can comprise displaying, via a display device, a seek option menu comprising a seek option that facilitates a location selection, via a remote device, of a defined location from a beginning of a data stream corresponding to a broadcast being received for display via the display device—in response to detecting, via the remote device, a seek request to seek to the defined location. Further, the method can comprise displaying, via the display device, content of the data stream starting from the defined location in response to receiving, via the remote device, the location selection of the defined location.

### TECHNICAL FIELD

The subject disclosure generally relates to facilitating playback from a specified position in time of a broadcast of a data stream.

### BACKGROUND

A user of broadcast services often desires to view portion(s) of a broadcast he/she has missed. However, conventional set-top box (STB) technologies limit the ability of viewers to access and/or view content of a data stream that has been broadcasted and/or that is pending being broadcast. Consequently, conventional STB technologies have had some drawbacks, some of which may be noted with reference to the various embodiments described herein below.

### BRIEF DESCRIPTION OF THE DRAWINGS

Non-limiting embodiments of the subject disclosure are described with reference to the following figures, wherein like reference numerals refer to like parts throughout the various views unless otherwise specified:

FIG. 1 illustrates a block diagram of a display comprising an option menu for facilitating playback from a specified position in time of a broadcast of a data stream, in accordance with various example embodiments;

FIG. 2 a block diagram of a satellite-based STB environment for facilitating playback from a specified position in time of a broadcast of a data stream, in accordance with various example embodiments;

FIG. 3 illustrates a block diagram of an STB for facilitating playback from a specified position in time of a broadcast of a data stream, in accordance with various example embodiments;

FIG. 4 illustrates a block diagram of a display comprising a seek option menu for facilitating playback from a specified position in time of a broadcast of a data stream, in accordance with various example embodiments;

FIG. 5 illustrates a block diagram of a display comprising a time selection for facilitating playback from a specified period of time from a beginning/end of a data stream, in accordance with various example embodiments;

FIG. 6 illustrates a block diagram of a display comprising a time window selection for facilitating playback from a specified location for a specified period of time, in accordance with various example embodiments;

FIG. 7 illustrates a block diagram of a display comprising a content selection for facilitating playback of content of a broadcast of a data stream corresponding to a specified characteristic of the content, in accordance with various example embodiments;

FIG. 8 illustrates a block diagram of a display comprising an option menu for facilitating playback from a specified position in time of a broadcast of a data stream, in accordance with various embodiments:

FIG. 9 illustrates a block diagram of another satellite-based STB environment for facilitating playback from a specified position in time of a broadcast of a data stream, in accordance with various embodiments;

FIGS. 10-12 illustrate block diagrams of a method performed by an STB for facilitating playback from a specified position in time of a broadcast of a data stream, in accordance with various example embodiments; and

FIG. 13 illustrates a block diagram representing an illustrative non-limiting computing system or operating environment in which one or more aspects of various embodiments described herein can be implemented.

### DETAILED DESCRIPTION

Aspects of the subject disclosure will now be described more fully hereinafter with reference to the accompanying drawings in which example embodiments are shown. In the following description, for purposes of explanation, numerous specific details are set forth in order to provide a thorough understanding of the various embodiments. However, the subject disclosure may be embodied in many different forms and should not be construed as limited to the example embodiments set forth herein.

As described above, conventional STB technologies have had some drawbacks with respect to enabling a viewer of a broadcast to access portion(s) of the broadcast that have already been broadcast and/or that are pending being broadcast. Various embodiments disclosed herein can facilitate playback from a specified position in time of a broadcast of a data stream.

For example, a method can comprise detecting, by an STB via a remote device, e.g., a remote control, a seek request to seek to a defined location from a beginning of a data stream corresponding to a broadcast currently being received by the STB and being displayed via a display device, e.g., a television (TV).

In an embodiment, the detecting of the seek request can comprise detecting that a button, key, etc. on the remote device corresponding to a pause request to pause a reception of the broadcast, a stop request to halt the reception of the broadcast, a rewind request to rewind to a portion of the broadcast, a fast forward request to fast forward to the portion of the broadcast, or the seek request has been selected. Further, in response to detecting that the button, key, etc. has been selected, the method can comprise displaying, via the display device, an option menu (e.g., within a broadcast window comprising a display of the broadcast) comprising identifiers, e.g., numbers, key identifiers, etc. representing the pause request, the stop request, the rewind request, the fast forward request, and the seek request, respectively.

In turn, in response to detecting a selection of an identifier representing the seek request, the method can comprise displaying, by the STB via the display device, a seek option menu comprising a location option that facilitates a location selection, via the remote device, of the defined location. Further, in response to receiving, via the remote device, the location selection of the defined location, the method can comprise displaying, by the system via the display device, content of the data stream starting from the defined location.

In an embodiment, the receiving of the location selection can comprise receiving a time selection representing a defined period of time from the beginning of the data stream. In one embodiment, the receiving of the location selection can comprise receiving a time selection representing a defined period of time from an end of the data stream. In another, embodiment, the receiving of the location selection can comprise receiving a time selection representing a defined period of time—the displaying comprising displaying the content of the data stream from the defined location for the defined period of time.

In yet another embodiment, the receiving of the location comprises receiving a content characteristic selection representing the location, e.g., the location corresponding to a specified characteristic of the content, e.g., in which a defined actor is performing the content, the defined actor is performing a defined action, or a defined event is occurring in the content.

In one embodiment, the displaying the content comprises sourcing an alternative data stream of the content, and displaying the alternative data stream from the defined location.

In another embodiment, the method can further comprise displaying, via the display device, an option menu comprising a trailer option that facilitates a display of a trailer, preview, etc. comprising portion(s) of the content, and in response to receiving, via the remote device, a trailer selection of the trailer option, displaying, via the display device, the trailer, preview, etc.

In yet another embodiment, the option menu can comprise an advertisement-free option that facilitates, based on a fee, an advertisement-free display of the content, and in response to receiving, via the remote device, an advertisement-free selection of the advertisement-free option, displaying, via the display device, the content without advertisements.

In an embodiment, the option menu can comprise an advertisement option that facilitates, without application of a fee, a display of the content with advertisements, and in response to receiving, via the remote device, an advertisement selection of the advertisement option, displaying, via the display device, the content with the advertisements.

In one embodiment, the option menu comprises a share option that facilitates a display, by a second display device, of portion(s) of the content.

Another embodiment can comprise a system, e.g., an STB based system, comprising a processor and a memory that stores executable instructions that, when executed by the processor, facilitate performance of operations, comprising: displaying first content of a data stream corresponding to a broadcast being received by the system; in response to detecting a first request to display second content of the data stream at a defined time specified from a beginning of the data stream, displaying a selection menu for facilitating a first selection of the defined time; and in response to receiving the first selection of the defined time, displaying the second content of the data stream from the defined time.

In yet another embodiment, the receiving of the first selection can comprise receiving a second selection of a defined duration of time—the displaying of the second content comprising displaying the second content of the data stream from the defined time for the defined duration of time.

In an embodiment, the operations can further comprise displaying a preview of the data stream in response to detecting a second request to display the preview. In one embodiment, the operations can further comprise displaying the second content without advertisements in response to detecting a second request to display, for a fee, the second content without advertisements. In another embodiment, the operations can further comprise displaying a portion of the second content via a registered, e.g., additional, device in response to detecting a second request to display the portion of the second content via the registered device.

One embodiment can comprise a machine-readable storage medium, comprising executable instructions that, when executed by a processor, facilitate performance of operations, comprising: displaying first content of a broadcast of a data stream; and in response to receiving first information representing a specified position in time from a beginning of the data stream, displaying second content of the broadcast from the specified position in time.

In another embodiment, the receiving of the first information can further comprise receiving second information representing a specified period of time—the displaying the second content comprising displaying the second content from the specified position in time for the specified period of time.

In yet another embodiment, the operations can further comprise obtaining the second content from a remote device, e.g., corresponding to a broadcast system of a cloud based streaming service, e.g., digital TV service, movie service, etc.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

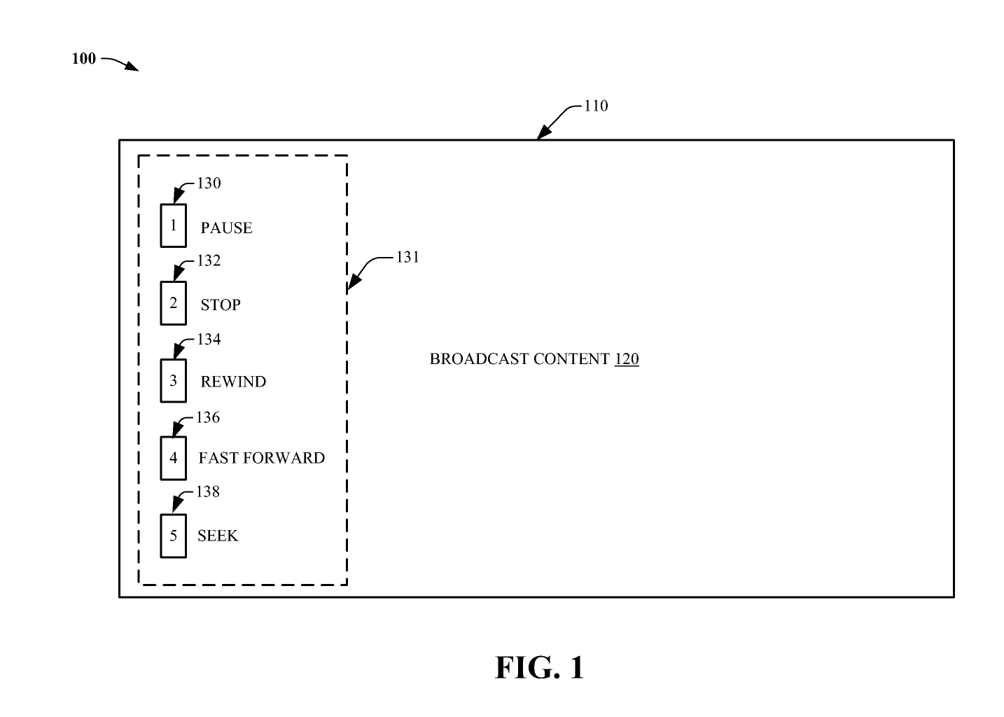

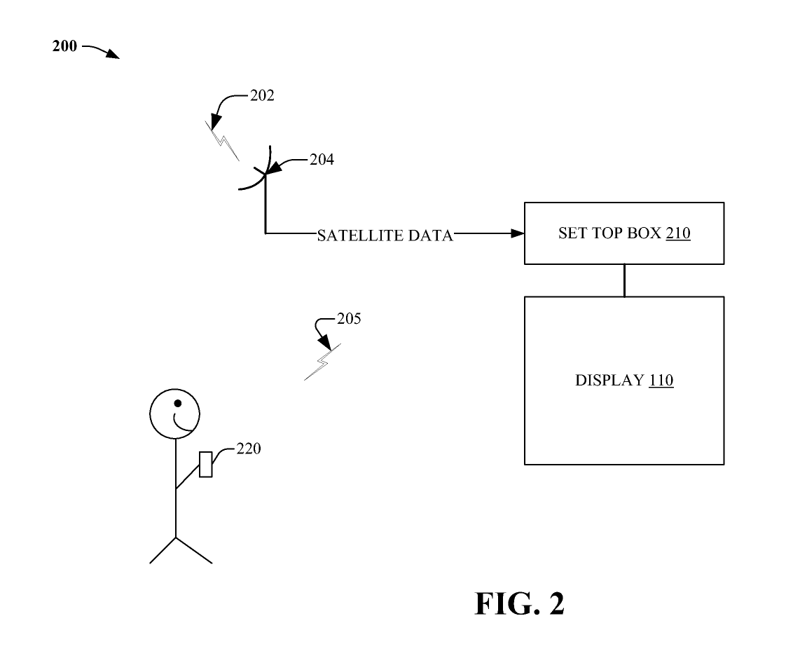

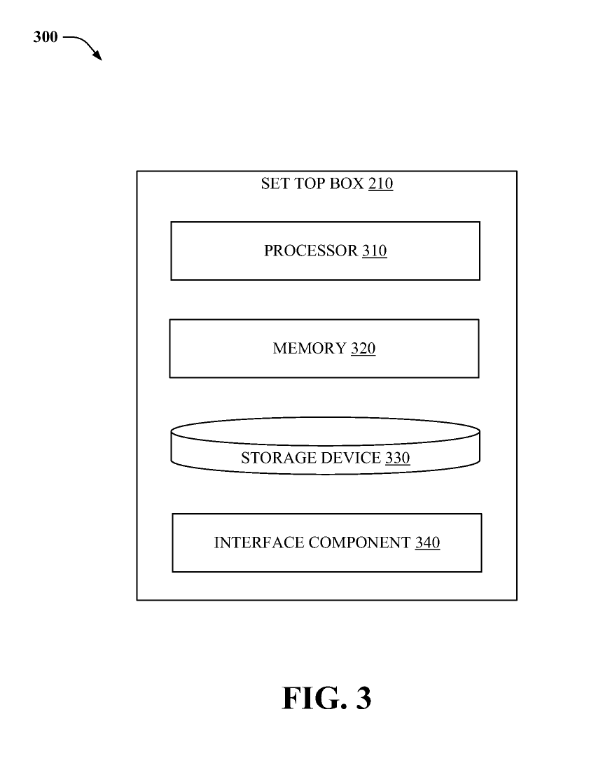

Referring now to FIGS. 1-4, a block diagram (100) of a display comprising an option menu for facilitating playback from a specified position in time of a broadcast of a data stream, a block diagram (200) of a satellite-based STB environment for facilitating the playback, a block diagram (300) of an STB for facilitating the playback, and a block diagram (400) of a display comprising a seek option menu for facilitating the playback are illustrated, respectively, in accordance with various example embodiments.

STB 210 comprises processor 310, memory 320, storage device 330, and interface component 340. In this regard, processor 310 can execute instructions stored in memory 320 to facilitate performance, by STB 210, of operations described herein. For example, in various embodiment(s), STB 210 can receive, via satellite receiver 204 (e.g., a satellite dish), satellite data representing wireless broadcasts 202 received from a satellite (not shown), e.g., comprising content of a broadcast of a data stream, broadcast streaming service, e.g., a direct-broadcast satellite television service. Further, interface component 340 can wirelessly couple, via wireless interface 205, STB 210 to remote device 220 in order to detect a request, input, etc. received from a user, e.g., for selecting features related to viewing the broadcast, the content of the broadcast of the data stream, etc.

In embodiment(s), the content of the broadcast of the data stream can comprise, e.g., a movie, a TV broadcast, etc. Further, STB 210 can be communicatively coupled to display 110, e.g., a TV, a display device, a monitor, etc. to facilitate viewing of such content.

As illustrated by FIG. 1, in response to detecting that a button, key, etc. on remote device 220 corresponding to, e.g., a pause request to pause a reception of the broadcast, a stop request to halt the reception of the broadcast, a rewind request to rewind to a portion of the broadcast, a fast forward request to fast forward to the portion of the broadcast, a seek request to seek to a defined location of the broadcast, e.g., from a beginning of the data stream, etc. has been selected, STB 210 can display, e.g., within display 110, e.g., within a display of broadcast 120, option menu 131, e.g., comprising identifiers (130, 132, 134, 136, 138) representing the pause request, the stop request, the rewind request, the fast forward request, and the seek request.

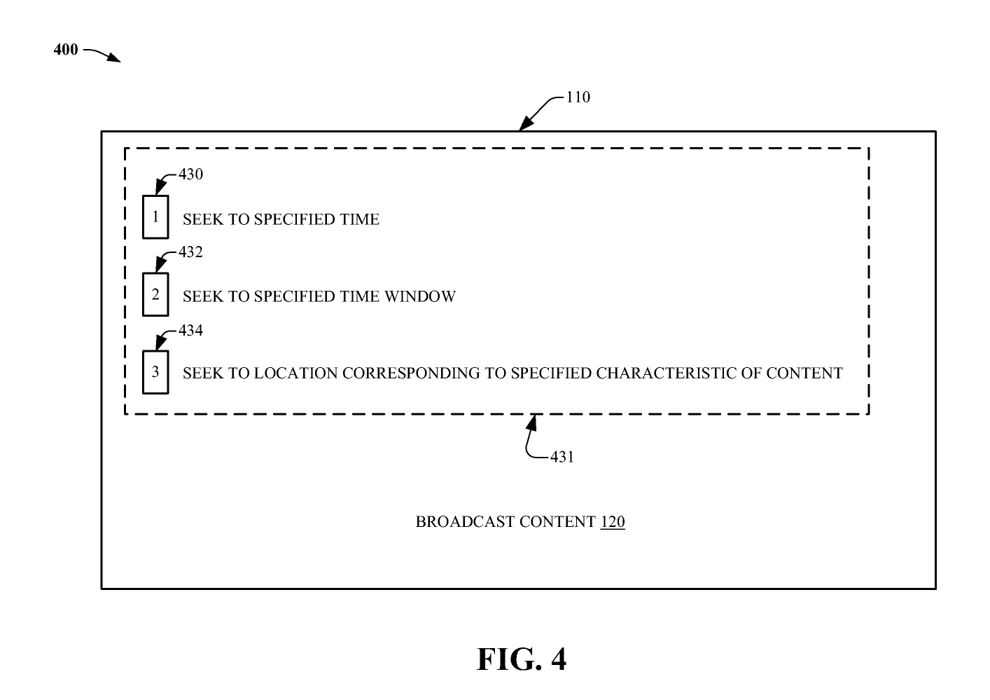

In turn, as illustrated by FIG. 4, in response to detecting, via remote device 220, a selection of an identifier (138), e.g., “5”, representing the seek request, STB 210 can display seek option menu 431 comprising identifiers (430, 432, 434) representing a request to seek: to a specified time from the beginning/end of the data stream for facilitating a display of content of the data stream starting from the specified time; to a specified time window/period of time of the data stream for facilitating a display of content of the data stream within the specified time window/period of time; and to a location within the data stream corresponding to a specified characteristic of content of the data stream.

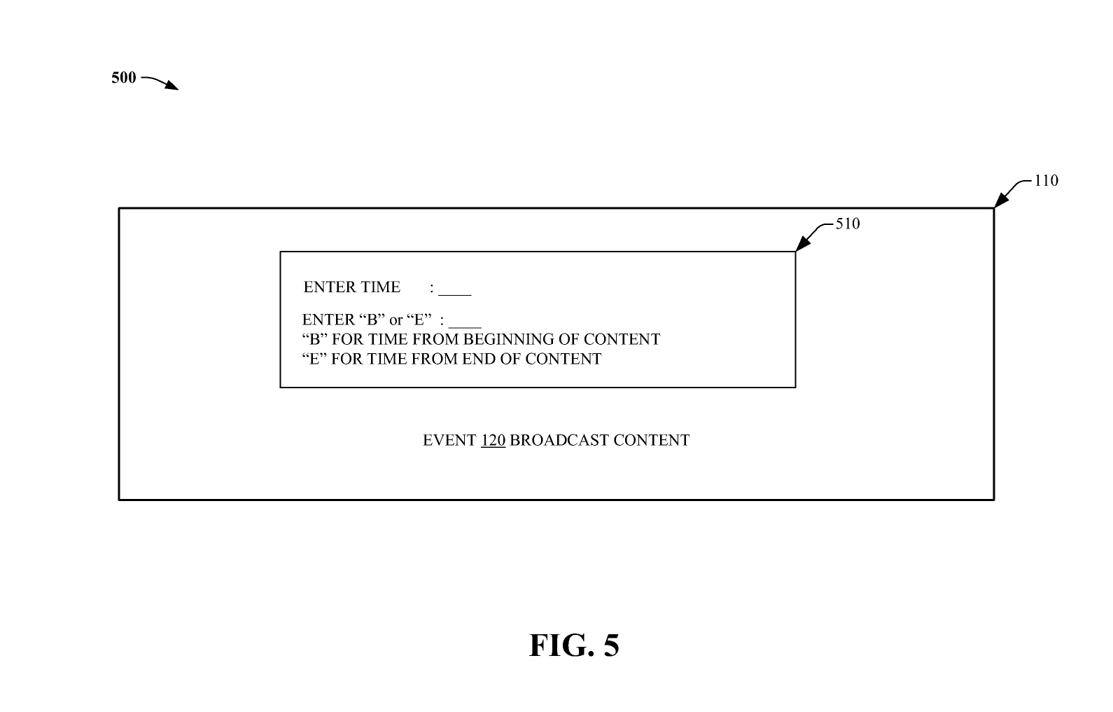

In this regard, and now referring to FIG. 5, in response to detecting, via remote device 220, a selection of an identifier (430), e.g., “1”, representing the request to seek to the specified time from the beginning/end of the data stream, STB 210 can receive a time selection representing a defined period of time from the beginning of the data stream. In another embodiment, STB 210 can receive the time selection representing a defined period of time from an end of the data stream. In turn, STB 210 can display, via display 110, content of the data stream starting from the specified time.

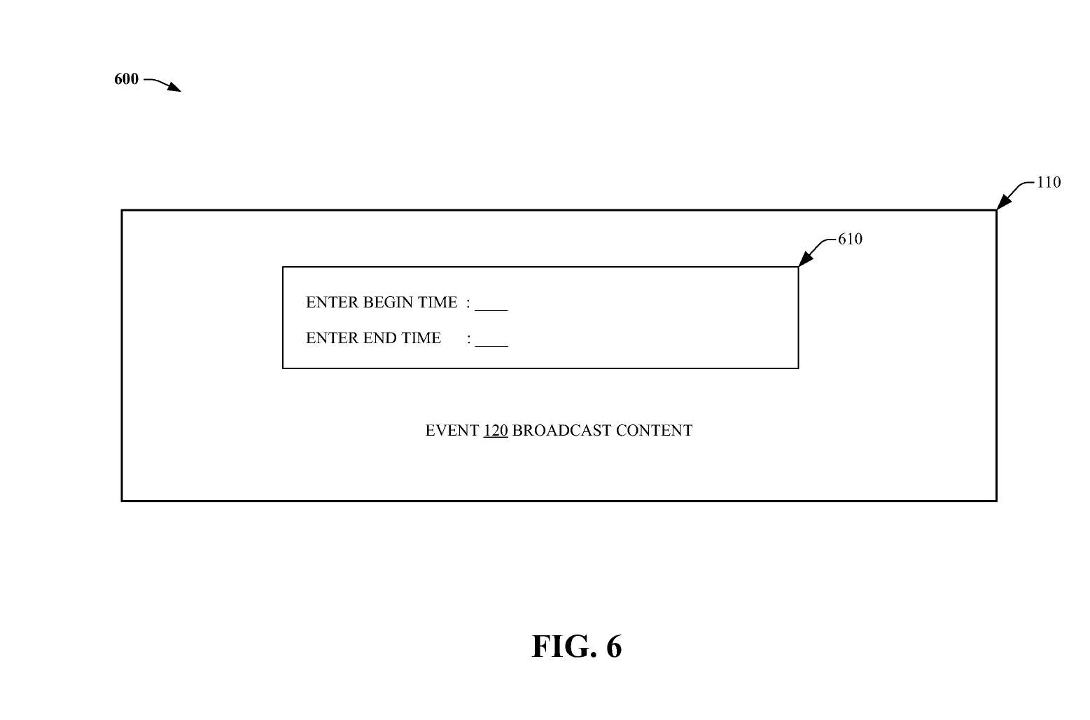

As illustrated by FIG. 6, in an embodiment, in response to detecting, via remote device 220, a selection of an identifier (432), e.g., “2”, representing the request to seek to the specified time window/period of time of the data stream, STB 210 can receive a time selection representing a defined period of time defined by a “begin time” and an “end time.” In turn, STB 210 can display, via display, the content of the data stream from begin time to the end time.

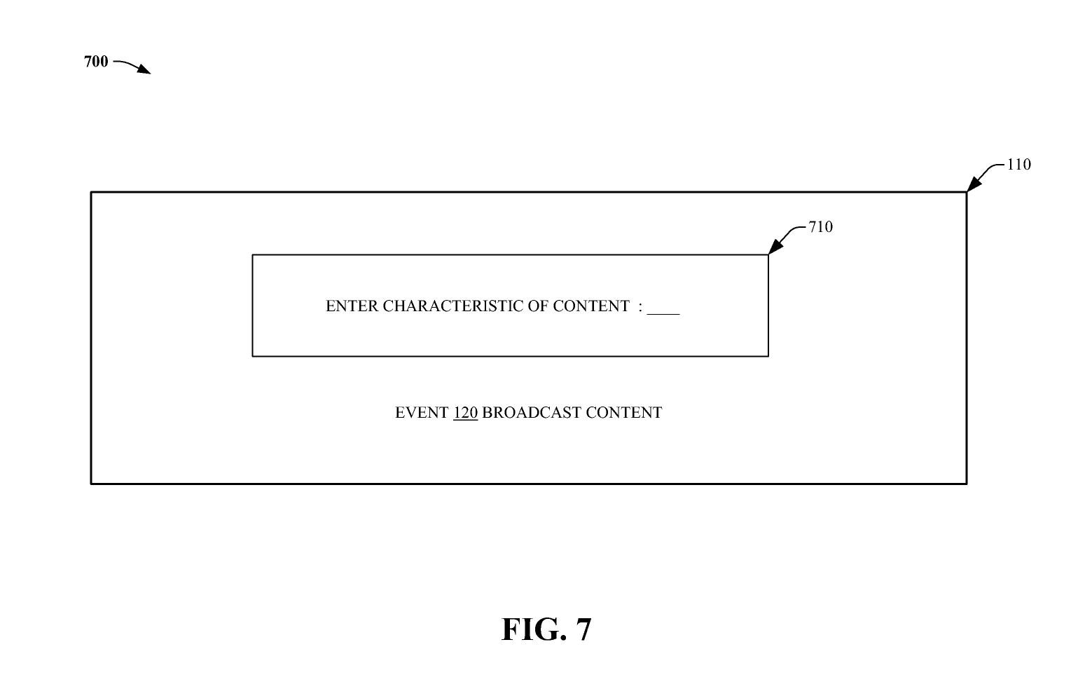

As illustrated by FIG. 7, in one embodiment, in response to detecting, via remote device 220, a selection of an identifier (434), e.g., “3”, representing the request to seek to the location within the data stream corresponding to the specified characteristic of the content of the data stream, STB 210 can receive a content characteristic selection representing the specified characteristic, e.g., an actor corresponding to the content, a defined action of the character, a defined event corresponding to the content, etc.

In this regard, in one embodiment, based on the content characteristic selection, STB 210 can send a search query comprising the content characteristic selection to a broadcast system (see e.g. 910 below), e.g., of cloud based digital TV service 905. In turn, the broadcast system can determine, based on the content characteristic selection, metadata representing location(s) of a data stream, alternate data stream, etc. corresponding to the content characteristic selection, and using the metadata, send portion(s) of the data stream corresponding to the specified characteristic, e.g., from the alternate data stream, to STB 210.

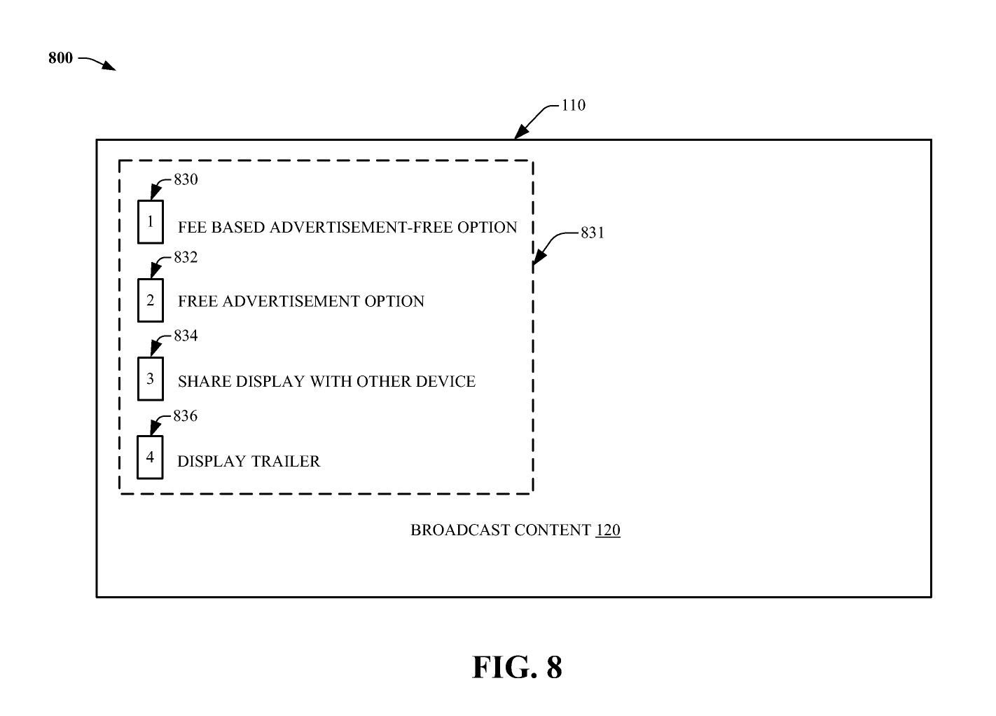

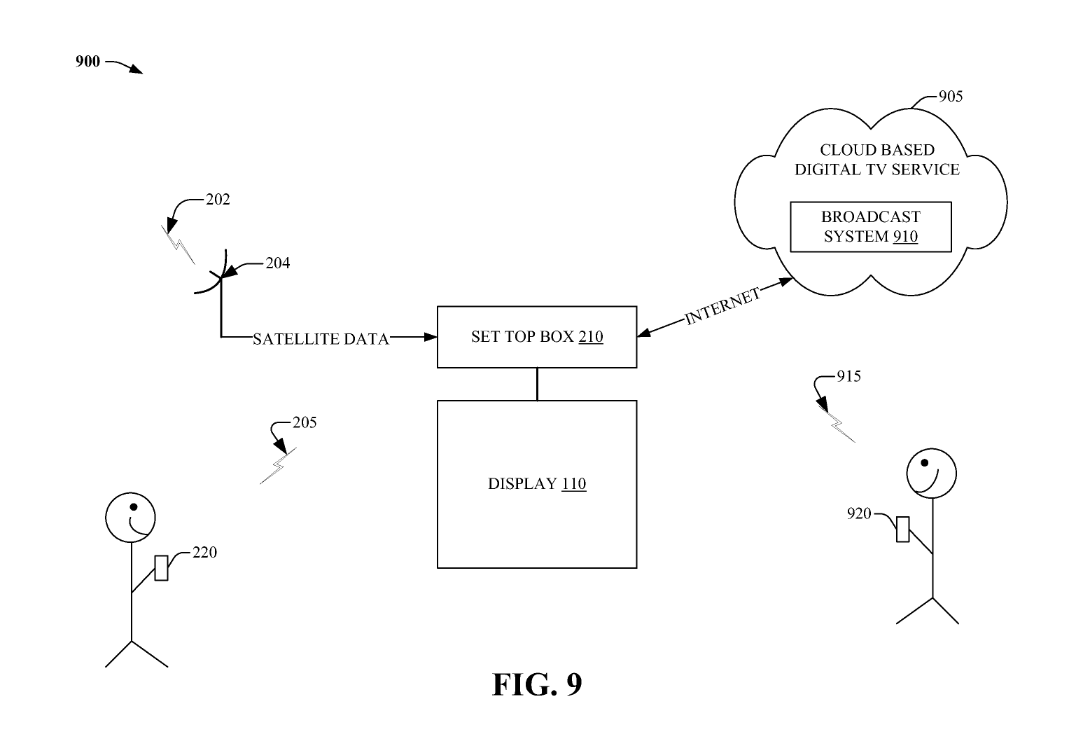

Referring now to FIGS. 8 and 9, a block diagram (800) of a display comprising an option menu (831), and a block diagram (900) illustrating sharing content of a broadcast with a remote device (920), e.g., portable electronic device, are illustrated, respectively, in accordance with various embodiments. As illustrated by FIG. 8, option menu 831 can comprise identifiers (830, 832, 834, 836) representing: an advertisement-free option that facilitates, based on application of a fee, an advertisement-free display of content of the data stream; an advertisement option that facilitates, without application of the fee, a display of the content of the data stream with advertisements; a share option that facilitates “sharing”, via STB 210, the content of the data stream with a second display device (e.g., 920); and a trailer option that facilitates a display of a trailer, preview, etc. comprising portion(s) of the content of the data stream.

In this regard, in response to detecting, via remote device 220, a selection of an identifier (830), e.g., “1”, representing a request to initiate the advertisement-free option, STB 210 can display, via display 110, content of the data stream, without advertisements, commercials, etc. after application of a nominal fee, e.g., less than $5.00, to an account of a user of STB 210, e.g., corresponding to cloud based digital TV service 905.

In another embodiment, in response to detecting, via remote device 220, a selection of an identifier (832), e.g., “2”, representing a request to initiate the advertisement option, STB 210 can display, via display 110, content of the data stream with advertisements, commercials, etc. for free—without application of the nominal fee to the account of the user.

In yet another embodiment, in response to detecting, via remote device 220, a selection of an identifier (834), e.g., “3”, representing a request to share portion(s) of the content of the data stream with another device, display device, etc. (e.g., 920), STB 210 can facilitate the display of the portion(s) of the content of the data stream, e.g., via wireless interface 915 (e.g., coupled to broadcast system 910 via the Internet), etc. with the other device, display device, etc., e.g., upon verification that the other device corresponds to, is registered with, etc. the account of the user.

In one embodiment, in response to detecting, via remote device 220, a selection of an identifier (836), e.g., “4”, representing a request to view a trailer, preview, etc. of the content of the data stream, STB 210 can display, via display 110, the trailer, preview, etc.

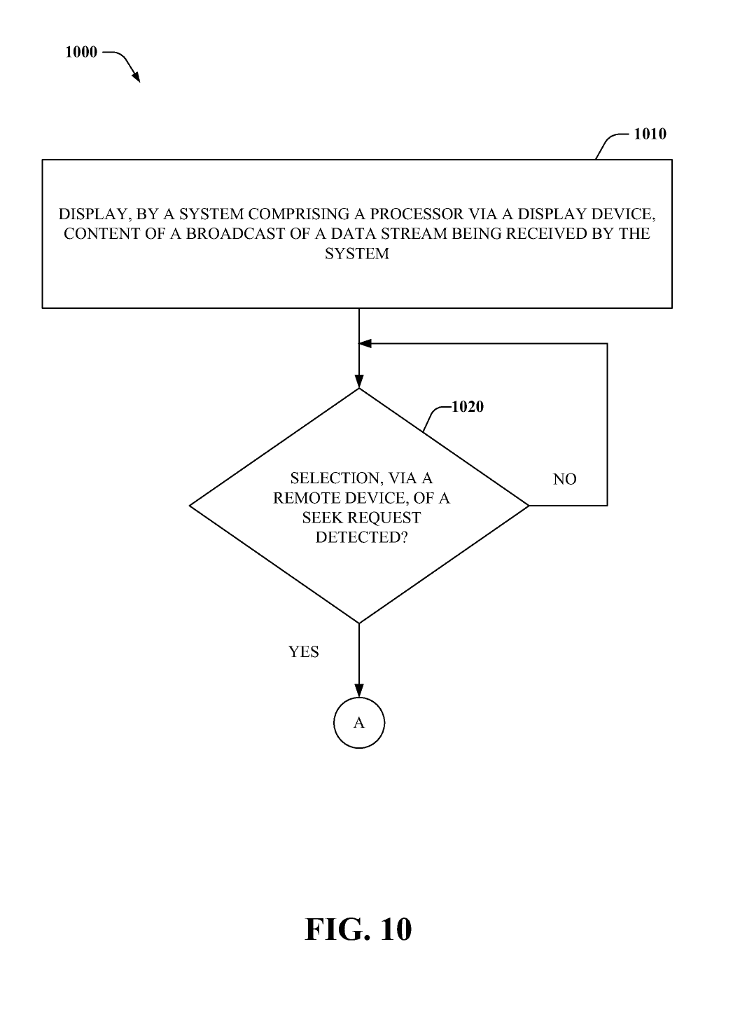

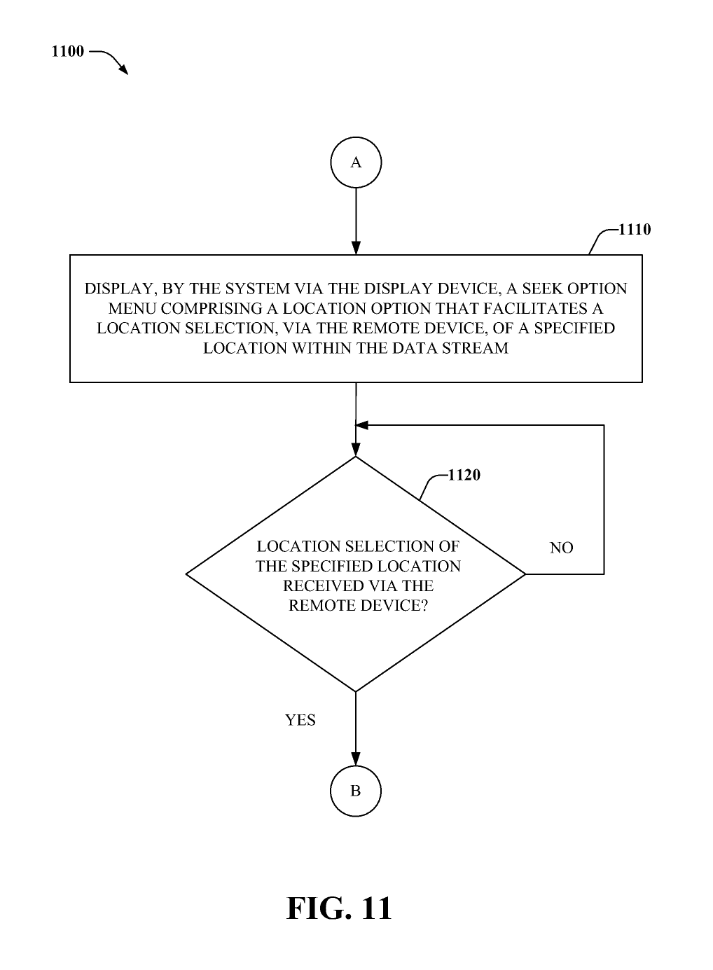

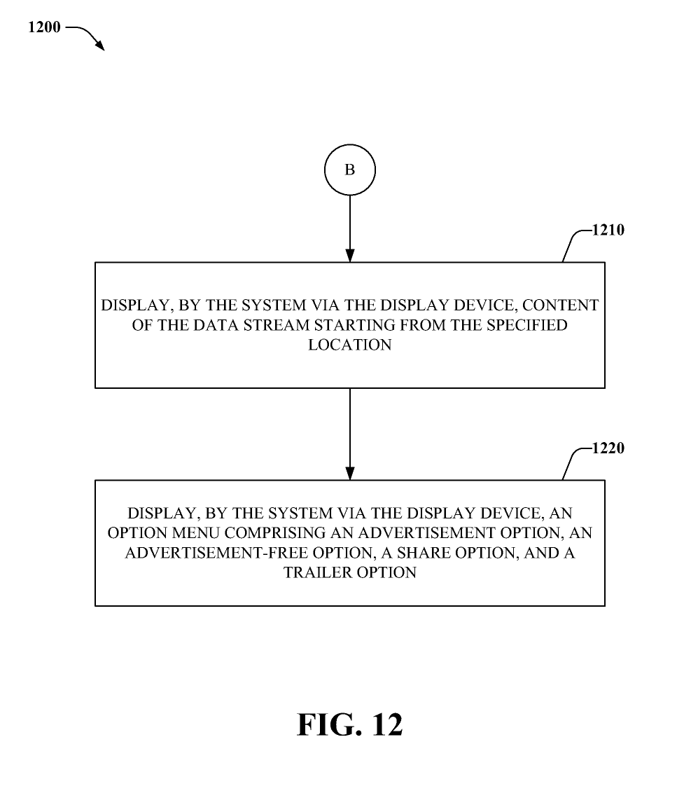

FIGS. 10-12 illustrate methodologies in accordance with the disclosed subject matter. For simplicity of explanation, the methodologies are depicted and described as a series of acts. It is to be understood and appreciated that the subject innovation is not limited by the acts illustrated and/or by the order of acts. For example, acts can occur in various orders and/or concurrently, and with other acts not presented or described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be further appreciated that some of the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Referring now to FIGS. 10-12, processes (1000-1200) performed by an STB (210) are illustrated, in accordance with various example embodiments. At 1010, the STB can display, via a display device, content of a broadcast of a data stream being received by the STB. At 1020, it can be determined whether a selection, via a remote device, of a seek request has been detected. In turn, in response to determining that the selection of the seek request has been detected, flow continues to 1110, otherwise flow returns to 1020.

At 1110, the STB can display, via the display device, a seek option menu comprising a location option that facilitates a location selection, via the remote device, of a specified location within the data stream.

At 1120, it can be determined whether the location selection of the specified location has been received via the remote device. In turn, in response to determining that the location selection has been received, flow continues to 1210, otherwise flow returns to 1120.

At 1210, the STB can display, via the display device, content of the data stream starting from the specified location. Further, at 1220, the STB can display, via the display device, an option menu comprising an advertisement option, an advertisement-free option, a share option, and a trailer option.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor may also be implemented as a combination of computing processing units.

In the subject specification, terms such as “storage device,” “disk storage,” “data store,” “data storage,” and substantially any other information storage component relevant to operation and functionality of a component and/or process, refer to “memory components,” or entities embodied in a “memory,” or components comprising the memory. It will be appreciated that the memory components described herein can be either volatile memory or nonvolatile memory, or can include both volatile and nonvolatile memory.

By way of illustration, and not limitation, nonvolatile memory, for example, can be included in memory 320, storage device 330, non-volatile memory 1322 (see below), disk storage 1324 (see below), and/or memory storage 1346 (see below). Further, nonvolatile memory can be included in read only memory (ROM), programmable ROM (PROM), electrically programmable ROM (EPROM), electrically erasable ROM (EEPROM), or flash memory. Volatile memory 1320 (see below) can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

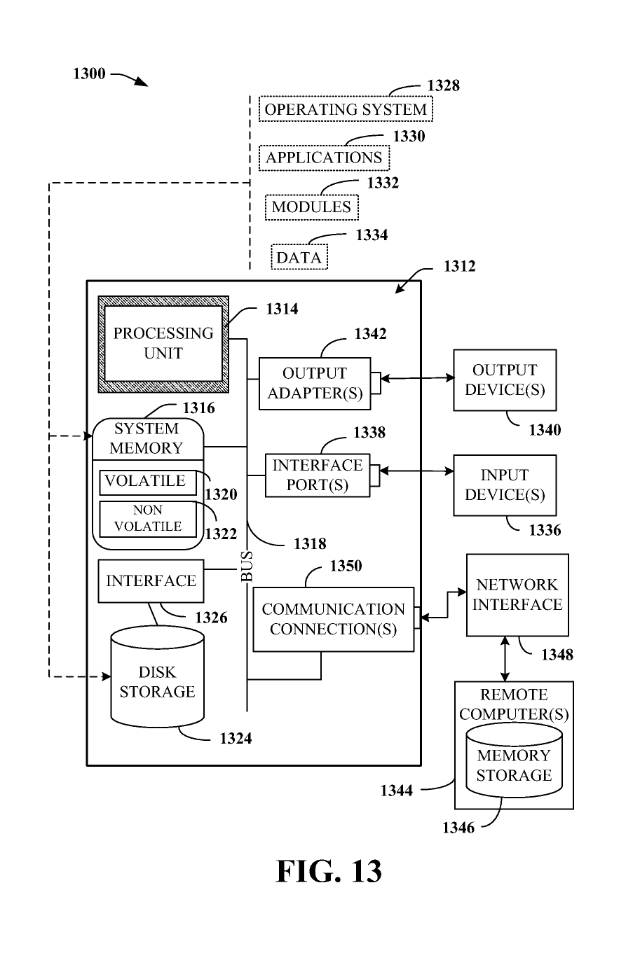

In order to provide a context for the various aspects of the disclosed subject matter, FIG. 13, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the subject innovation also can be implemented in combination with other program modules. Generally, program modules include routines, programs, components, data structures, etc. that perform particular tasks and/or implement particular abstract data types.

Moreover, those skilled in the art will appreciate that the inventive systems can be practiced with other computer system configurations, including single-processor or multiprocessor computer systems, mini-computing devices, mainframe computers, as well as personal computers, hand-held computing devices (e.g., PDA, phone, watch), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

With reference to FIG. 13, a block diagram of a computing system 1300 operable to execute the disclosed components, systems, devices, etc., e.g., STB 310, is illustrated, in accordance with an embodiment. Computer 1312 includes a processing unit 1314, a system memory 1316, and a system bus 1318. System bus 1318 couples system components including, but not limited to, system memory 1316 to processing unit 1314. Processing unit 1314 can be any of various available processors. Dual microprocessors and other multiprocessor architectures also can be employed as processing unit 1314.

System bus 1318 can be any of several types of bus structure(s) including a memory bus or a memory controller, a peripheral bus or an external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), Small Computer Systems Interface (SCSI), and/or controller area network (CAN) bus used in vehicles.

System memory 1316 includes volatile memory 1320 and nonvolatile memory 1322. A basic input/output system (BIOS), containing routines to transfer information between elements within computer 1312, such as during start-up, can be stored in nonvolatile memory 1322. By way of illustration, and not limitation, nonvolatile memory 1322 can include ROM, PROM, EPROM, EEPROM, or flash memory. Volatile memory 1320 includes RAM, which acts as external cache memory. By way of illustration and not limitation, RAM is available in many forms such as SRAM, dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1312 also includes removable/non-removable, volatile/non-volatile computer storage media. FIG. 13 illustrates, for example, disk storage 1324. Disk storage 1324 includes, but is not limited to, devices like a magnetic disk drive, floppy disk drive, tape drive, Jaz drive, Zip drive, LS-100 drive, flash memory card, or memory stick. In addition, disk storage 1324 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1324 to system bus 1318, a removable or non-removable interface is typically used, such as interface 1326.

It is to be appreciated that FIG. 13 describes software that acts as an intermediary between users and computer resources described in suitable operating environment 1300. Such software includes an operating system 1328. Operating system 1328, which can be stored on disk storage 1324, acts to control and allocate resources of computer system 1312. System applications 1330 take advantage of the management of resources by operating system 1328 through program modules 1332 and program data 1334 stored either in system memory 1316 or on disk storage 1324. It is to be appreciated that the disclosed subject matter can be implemented with various operating systems or combinations of operating systems.

A user can enter commands or information into computer 1312 through input device(s) 1336. Input devices 1336 include, but are not limited to, a pointing device such as a mouse, trackball, stylus, touch pad, keyboard, microphone, joystick, game pad, satellite dish, scanner, TV tuner card, digital camera, digital video camera, web camera, cellular phone, user equipment, smartphone, and the like. These and other input devices connect to processing unit 1314 through system bus 1318 via interface port(s) 1338. Interface port(s) 1338 include, for example, a serial port, a parallel port, a game port, a universal serial bus (USB), a wireless based port, e.g., WiFi, Bluetooth®, etc. Output device(s) 1340 use some of the same type of ports as input device(s) 1336.

Thus, for example, a USB port can be used to provide input to computer 1312 and to output information from computer 1312 to an output device 1340. Output adapter 1342 is provided to illustrate that there are some output devices 1340, like display devices, light projection devices, monitors, speakers, and printers, among other output devices 1340, which use special adapters. Output adapters 1342 include, by way of illustration and not limitation, video and sound devices, cards, etc. that provide means of connection between output device 1340 and system bus 1318. It should be noted that other devices and/or systems of devices provide both input and output capabilities such as remote computer(s) 1344.

Computer 1312 can operate in a networked environment using logical connections to one or more remote computers, such as remote computer(s) 1344. Remote computer(s) 1344 can be a personal computer, a server, a router, a network PC, a workstation, a microprocessor based appliance, a peer device, or other common network node and the like, and typically includes many or all of the elements described relative to computer 1312.

For purposes of brevity, only a memory storage device 1346 is illustrated with remote computer(s) 1344. Remote computer(s) 1344 is logically connected to computer 1312 through a network interface 1348 and then physically and/or wirelessly connected via communication connection 1350. Network interface 1348 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1350 refer(s) to hardware/software employed to connect network interface 1348 to bus 1318. While communication connection 1350 is shown for illustrative clarity inside computer 1312, it can also be external to computer 1312. The hardware/software for connection to network interface 1348 can include, for example, internal and external technologies such as modems, including regular telephone grade modems, cable modems and DSL modems, wireless modems, ISDN adapters, and Ethernet cards.

The computer 1312 can operate in a networked environment using logical connections via wired and/or wireless communications to one or more remote computers, cellular based devices, user equipment, smartphones, or other computing devices, such as workstations, server computers, routers, personal computers, portable computers, microprocessor-based entertainment appliances, peer devices or other common network nodes, etc. The computer 1312 can connect to other devices/networks by way of antenna, port, network interface adaptor, wireless access point, modem, and/or the like.

The computer 1312 is operable to communicate with any wireless devices or entities operatively disposed in wireless communication, e.g., a printer, scanner, desktop and/or portable computer, portable data assistant, communications satellite, user equipment, cellular base device, smartphone, any piece of equipment or location associated with a wirelessly detectable tag (e.g., scanner, a kiosk, news stand, restroom), and telephone. This includes at least WiFi and Bluetooth® wireless technologies. Thus, the communication can be a predefined structure as with a conventional network or simply an ad hoc communication between at least two devices.

WiFi allows connection to the Internet from a desired location (e.g., a vehicle, couch at home, a bed in a hotel room, or a conference room at work, etc.) without wires. WiFi is a wireless technology similar to that used in a cell phone that enables such devices, e.g., mobile phones, computers, etc., to send and receive data indoors and out, anywhere within the range of a base station. WiFi networks use radio technologies called IEEE 802.11 (a, b, g, etc.) to provide secure, reliable, fast wireless connectivity. A WiFi network can be used to connect communication devices (e.g., mobile phones, computers, etc.) to each other, to the Internet, and to wired networks (which use IEEE 802.3 or Ethernet). WiFi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

Further, to the extent that the terms “includes,” “has,” “contains,” and other similar words are used in either the detailed description or the appended claims, such terms are intended to be inclusive—in a manner similar to the term “comprising” as an open transition word—without precluding any additional or other elements. Moreover, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Furthermore, the word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art.

As utilized herein, terms “service”, “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a computer and the computer can be a component. One or more components can reside within a process, and a component can be localized on one computer and/or distributed between two or more computers.

Further, components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components.

Aspects of systems, apparatus, and processes explained herein can constitute machine-executable instructions embodied within a machine, e.g., embodied in a computer readable medium (or media) associated with the machine. Such instructions, when executed by the machine, can cause the machine to perform the operations described. Additionally, the systems, processes, process blocks, etc. can be embodied within hardware, such as an application specific integrated circuit (ASIC) or the like. Moreover, the order in which some or all of the process blocks appear in each process should not be deemed limiting. Rather, it should be understood by a person of ordinary skill in the art having the benefit of the instant disclosure that some of the process blocks can be executed in a variety of orders not illustrated.

The disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, magnetic storage devices, e.g., hard disk; floppy disk; magnetic strip(s); optical disk (e.g., compact disk (CD), digital video disc (DVD), Blu-ray Disc (BD)); smart card(s); and flash memory device(s) (e.g., card, stick, key drive); and/or a virtual device that emulates a storage device and/or any of the above computer-readable media.

Artificial intelligence based systems, e.g., utilizing explicitly and/or implicitly trained classifiers, can be employed in connection with performing inference and/or probabilistic determinations and/or statistical-based determinations as in accordance with one or more aspects of the disclosed subject matter as described herein. For example, an artificial intelligence system can be used, via STB 210, to perform operations comprising: displaying first content of a data stream corresponding to a broadcast being received by STB 210; in response to detecting a first request to display second content of the data stream at a defined time specified from a beginning of the data stream, displaying a selection menu for facilitating a first selection of the defined time; and in response to receiving the first selection of the defined time, displaying the second content of the data stream from the defined time.

A classifier can be a function that maps an input attribute vector, x=(x1, x2, x3, x4, xn), to a confidence that the input belongs to a class, that is, f(x)=confidence (class). Such classification can employ a probabilistic and/or statistical-based analysis (e.g., factoring into the analysis utilities and costs) to infer an action that a user desires to be automatically performed. In the case of communication systems, for example, attributes can be information received from access points, services, components of a wireless communication network, etc., and the classes can be categories or areas of interest (e.g., levels of priorities). A support vector machine is an example of a classifier that can be employed. The support vector machine operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein can also be inclusive of statistical regression that is utilized to develop models of priority.

In accordance with various aspects of the subject specification, artificial intelligence based systems, components, etc. can employ classifiers that are explicitly trained, e.g., via a generic training data, etc. as well as implicitly trained, e.g., via observing characteristics of event notifications reported by a file system, e.g., corresponding to checksum error(s), receiving operator preferences, receiving historical information, receiving extrinsic information, etc. For example, support vector machines can be configured via a learning or a training phase within a classifier constructor and feature selection module. Thus, the classifier(s) can be used by an artificial intelligence system to automatically learn and perform a number of functions, e.g., performed by STB 210, etc.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

1. A method, comprising:
in response to detecting, via a remote device, a seek request to seek to a defined location from a beginning of a data stream corresponding to a broadcast being received for display via a display device, displaying, by a system comprising a processor via the display device, a seek option menu comprising a location option that facilitates a location selection, via the remote device, of the defined location;
in response to receiving, via the remote device, the location selection, displaying, by the system via the display device, content of the data stream starting from the defined location; and
in response to receiving, via the remote device, a request to share at least a portion of the content of the data stream with an auxiliary device, and in response to determining, based on the request, that the auxiliary device has been registered with an account corresponding to the remote device, displaying, by the system, the portion of the content of the data stream via the auxiliary device.

2. The method of claim 1, wherein the detecting the seek request comprises:
detecting, via the remote device, a selection of a group of selections, the group of selections comprising a pause request to pause a reception of the broadcast, a stop request to halt a reception of the broadcast, a rewind request to rewind to a portion of the broadcast, a fast forward request to fast forward to a portion of the broadcast; and
displaying, via the display device, an option menu comprising identifiers representing respective selections of the group of selections and the seek request.

3. The method of claim 1, wherein the receiving the location selection comprises:
receiving a time selection representing a defined period of time from the beginning of the data stream.

4. The method of claim 1, wherein the receiving the location selection comprises:
receiving a time selection representing a defined period of time from an end of the data stream.

5. The method of claim 1, wherein the receiving the location selection comprises:
receiving a time selection representing a defined period of time, and wherein the displaying comprises displaying the content of the data stream from the defined location for the defined period of time.

6. The method of claim 1, wherein the receiving the location selection comprises:
receiving a content characteristic selection representing a characteristic of the content.

7. The method of claim 6, wherein the characteristic is from a group of characteristics, the group of characteristics comprising a defined actor corresponding to the content, a defined action of the defined actor, and a defined event corresponding to the content.

8. The method of claim 1, wherein the displaying the content comprises:
sourcing an alternative data stream of the content; and
displaying the alternative data stream from the defined location.

9. The method of claim 1, further comprising:
displaying, via the display device, an option menu comprising a trailer option that facilitates a display of a trailer comprising portions of the content; and
in response to receiving, via the remote device, a trailer selection of the trailer option, displaying, via the display device, the trailer.

10. The method of claim 1, further comprising:
displaying, via the display device, an option menu comprising an advertisement-free option that facilitates, based on a fee, an advertisement-free display of the content; and
in response to receiving, via the remote device, an advertisement-free selection of the advertisement-free option, displaying, via the display device, the content without advertisements.

11. The method of claim 1, further comprising:
displaying, via the display device, an option menu comprising an advertisement option that facilitates, without application of a fee, a display of the content with advertisements; and
in response to receiving, via the remote device, an advertisement selection of the advertisement option, displaying, via the display device, the content with the advertisements.

12. The method of claim 1, wherein the display device is a first display device, and the method further comprises:
displaying, via the display device, an option menu comprising a share option that facilitates a display, by a second display device, of at least a portion of the content.

13. A system, comprising:
a processor; and
a memory that stores executable instructions that, when executed by the processor, facilitate performance of operations, the operations comprising:
displaying, via a first display of the system, first content of a data stream corresponding to a broadcast being received by the system;
in response to detecting a first request to display second content of the data stream at a defined time specified from a beginning of the data stream, displaying, via the first display, a selection menu for facilitating a first selection of the defined time;
in response to receiving the first selection of the defined time, displaying, via the first display, the second content of the data stream from the defined time; and
in response to detecting a second request to display at least a portion of the second content of the data stream in a second display of a device, and in response to determining that the device has been registered with an account corresponding to the system, displaying the portion of the second content of the data stream via the second display.

14. The system of claim 13, wherein the receiving the first selection comprises:
receiving a second selection of a defined duration of time, and wherein the displaying the second content comprises displaying the second content of the data stream from the defined time for the defined duration of time.

15. The system of claim 13, wherein the operations further comprise:
in response to detecting a third request to display a preview of the data stream, displaying the preview.

16. The system of claim 13, wherein the operations further comprise:
in response to detecting a third request to display, for a fee, the second content without advertisements, displaying the second content without advertisements.

17. The system of claim 13, wherein the displaying the portion of the second content of the data stream via the second display comprises displaying the portion of the second content of the data stream via the second display via an 802.XX wireless interface.

18. A non-transitory machine-readable storage medium, comprising executable instructions that, when executed by a processor, facilitate performance of operations, comprising:
displaying first content of a broadcast of a data stream corresponding to a data stream service;
in response to receiving first information representing a specified position in time from a beginning of the data stream, displaying second content of the broadcast from the specified position in time; and
based on a request to display at least a portion of the second content via a device that has been registered with an account corresponding to the data stream service, displaying the portion of the second content via the device.

19. The non-transitory machine-readable storage medium of claim 18, wherein the operations further comprise:
obtaining the second content from a remote device.

20. The non-transitory machine-readable storage medium of claim 18, wherein the receiving the first information comprises:
receiving second information representing a specified period of time, and wherein the displaying the second content comprises displaying the second content from the specified position in time for the specified period of time.
